(19) United States
(12) Patent Application Publication
(10) Pub. No.: US 2026/0073809 A1
(43) Pub. Date: Mar. 12, 2026

(54) PILOT ASSESSMENT BASED ON COGNITIVE NEURAL DATA

(71) Applicant: HONEYWELL INTERNATIONAL INC., Charlotte, NC (US)

(72) Inventors: Tor Finseth, Plymouth, MN (US); Nichola Lubold, Phoenix, AZ (US)

(73) Assignee: HONEYWELL INTERNATIONAL INC., Charlotte, NC (US)

(21) Appl. No.: 18/883,414

(22) Filed: Sep. 12, 2024

(51) Int. Cl. G09B 9/30; G06F 3/01; G10L 15/26

(52) U.S. Cl. CPC G09B 9/302; G06F 3/013; G06F 3/015; G10L 15/26

(57) ABSTRACT

A system and method for developing an individualized assessment for a pilot based upon cognitive brain scan data has been developed. The system includes an aircraft simulator that simulates aircraft tasks for the pilot. During simulated aircraft tasks, behavior sensors are used to track behavioral aspects of the pilot, physiological sensors are used to track physiological aspects of the pilot and neural brain sensors are used to track neural signals of the pilot. A transcription model transcribes the neural signals of the pilot into words based on vocalization from the pilot during the simulated aircraft tasks. A data synchronization system synchronizes the behavioral aspects, the physiological aspects, the neural signals and the transcribed words of the pilot into an individualized dataset for the pilot. The dataset is used to develop an individualized training assessment for the pilot.

### TECHNICAL FIELD

The present invention generally relates to aviation simulation, and more particularly relates to pilot assessment based on cognitive neural data.

### BACKGROUND

Every human uses some type of cognitive skill to conduct tasks, but the stability of these skills are even more important in aircraft operation. However, when introducing new information automation within vehicles, the automation may exclusively affect a subset of cognitive skills. The use of automated systems in modern flight decks has also been linked to a reduction in cognitive skill proficiencies needed for flying and flight path management. Hence, there is a need for a system for pilot training assessment based on cognitive neural data.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A system is provided for developing an individualized training assessment for a pilot based upon cognitive brain scan data. The system comprises: an aircraft simulator that simulates aircraft tasks for the pilot; behavior sensors that track behavioral aspects of the pilot during the simulated aircraft tasks; physiological sensors that track physiological aspects of the pilot during the simulated aircraft tasks; neural brain sensors that track neural signals of the pilot during the simulated aircraft tasks; a transcription model that transcribes the neural signals of the pilot into transcribed words based on vocalization from the pilot during the simulated aircraft tasks; and a data synchronization system that synchronizes the behavioral aspects, the physiological aspects, the neural signals and the transcribed words of the pilot during the simulated aircraft tasks into an individualized dataset for the pilot, where the dataset is used to develop an individualized assessment for the pilot that can be used to facilitate training and other activities.

A method is provided for developing an individualized assessment for a pilot based upon cognitive brain scan data. The method comprises: simulating aircraft tasks for the pilot with an aircraft simulator; tracking behavioral aspects of the pilot during the simulated aircraft tasks with behavior sensors; tracking physiological aspects of the pilot during the simulated aircraft tasks with physiological sensors; tracking neural signals of the pilot during the simulated aircraft tasks with neural brain sensors; transcribing the neural signals of the pilot into transcribed words based on vocalization from the pilot during the simulated aircraft tasks with a transcription model; and synchronizing the behavioral aspects, the physiological aspects, the neural signals and the transcribed words of the pilot during the simulated aircraft tasks into an individualized dataset for the pilot with a data synchronization system, where the dataset is used to develop an individualized assessment for the pilot that can be used to facilitate training and other activities.

Furthermore, other desirable features and characteristics of the disclosed embodiments will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figures, wherein like numerals denote like elements, and wherein:

FIG. 1 is a diagram of a flight simulator in accordance with disclosed embodiments;.

FIG. 2 is a diagram of an eye-tracker system in accordance with disclosed embodiments;

FIG. 3 is a diagram of an electro-encephalogram (EEG) sensor in accordance with disclosed embodiments;

FIG. 4 is a block diagram of pilot assessment system based on cognitive neural data in accordance with disclosed embodiments; and

FIG. 5 is a flowchart of a method for developing an individualized assessment for a pilot based upon cognitive brain scan data in accordance with disclosed embodiments.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

A system and method for developing an individualized assessment for a pilot based upon cognitive brain scan data has been developed. The system includes an aircraft simulator that simulates aircraft tasks for the pilot. During simulated aircraft tasks, behavior sensors are used to track behavioral aspects of the pilot, physiological sensors are used to track physiological aspects of the pilot and neural brain sensors are used to track neural signals of the pilot. A transcription model transcribes the neural signals of the pilot into words based on vocalization from the pilot during the simulated aircraft tasks. A data synchronization system synchronizes the behavioral aspects, the physiological aspects, the neural signals and the transcribed words of the pilot into an individualized dataset for the pilot. The dataset is used to develop an individualized training assessment for the pilot. Embodiments of this disclosure detect and qualitatively analyze skill proficiency for cognitive tasks in simulators (e.g., training vehicles, simulators, virtual reality) by using artificial intelligence (AI) and machine learning (ML) techniques to transcribe an inner monologue of a pilot through neural signals, and then synchronize the neural signals to simulator data, physiological sensors, and task related metrics.

Cognitive skills are mental resources used in the application of knowledge to a task utilizing basic skills such as thinking, reading, learning, remembering, and reasoning. Every human uses some type of cognitive skill to conduct tasks, but the stability of these skills are even more important in aircraft operation. For example, several critical cognitive skills identified for pilots are flight planning and flight path management. These skills are not trained to pilots explicitly and are assumed to be consistent across individual pilots. However, when introducing new information automation capabilities within vehicles, the automation may exclusively affect a subset of cognitive skills.

For example, the reallocation of pilot tasks to an automated system may decay skills through forgetfulness, lack of practice, lack of use, etc. The use of automated systems in modern flight decks has also been linked to a reduction in cognitive skill proficiencies needed for manual flying. As a result, the cognitive skills of a pilot may not be as stable as originally thought and instead show varying levels of proficiency. It is therefore important to regularly assess and verify these skills for pilots. Since multiple cognitive skills may be used to conduct a task, measuring these skills becomes very difficult using task performance metrics alone.

The research disciplines of cognitive engineering and heuristic decision making have primarily measured task related skills using procedural experiments where the researcher probes the participants with questions about their thought processes during or after completing a task (e.g., verbal protocols, cognitive walkthrough, shadowbox technique). This process provides better insight into cognitive skills rather than a simple objective measure of task performance. However, it is long and arduous endeavor because researchers must observe the behavior and then stop participants at different intervals (sometimes in the middle of the task) to ask the questions. Often hours of video, audio recordings, and several hierarchical task diagrams are necessary to identify the skills that underly the participant's performance.

Disclosed embodiments use neural brain sensors (e.g., functional magnetic resonance imaging (fMRI), electro-encephalogram (EEG), functional near-infrared spectroscope (FNIR)), physiological sensors (e.g., heart rate monitor), behavioral sensors (e.g., eye tracker) and AI/ML to output an internal monologue of the pilot. The output is paired with training simulator (e.g., training vehicles, simulators, virtual reality) data related to specific tasks in order to collect and qualitatively assess the internal dialogues relationship to any cognitive skills and also the degree to which those skills are used by the pilot throughout the task.

The system involves several main components: a training simulator (a training vehicle, a virtual reality system, full-motion mock-ups, etc.); physiological/behavioral user tracking systems (speech, face recognition, eye tracking, heart rate, etc.); neural sensors (EEG, FMRI, FNIR, etc.); and a computer system for creating, processing and storing datasets using AI/ML. Specifically, the components break down as follows. The training simulator simulates realistic tasks and scenarios. It coordinates with other components to provide context and data related to specific tasks being performed by the pilot. The physiological sensors monitor physiological responses that might correlate with cognitive processes. These sensors complement neural brain sensors to provide a more comprehensive view of the human state. The neural brain sensors measure neural signals corresponding to the participant's cognitive processes and inner monologue. The behavior sensors track behavioral aspects such as eye movements to provide additional insights into task performance. These sensors work in conjunction with neural brain sensors and physiological sensors to analyze human behavior in real-time. The computer system includes a model for transcription that transcribes neural signals into coherent thoughts by receiving neural data from the brain sensors and translating the data into transcribed words. The computer system also includes a data synchronization system which integrates and synchronizes data from all sensors, simulator, and transcription to create a comprehensive dataset. It interacts with all components to collect, align, and correlate data for analysis.

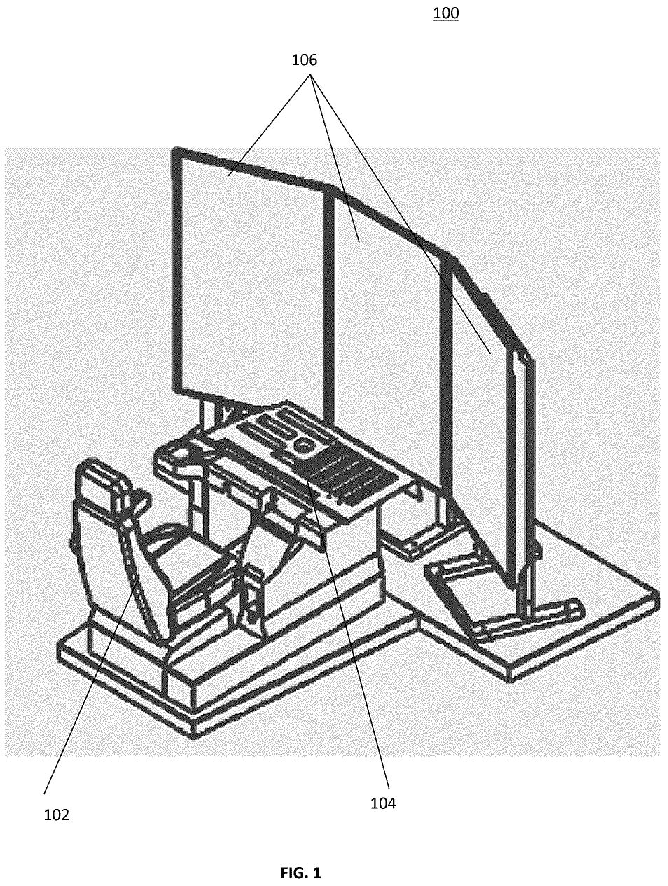

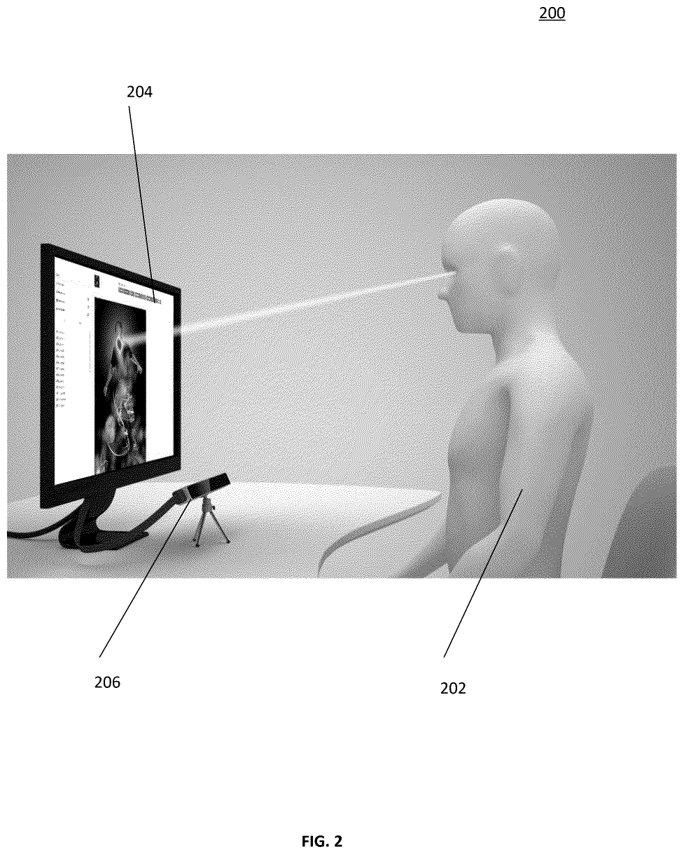

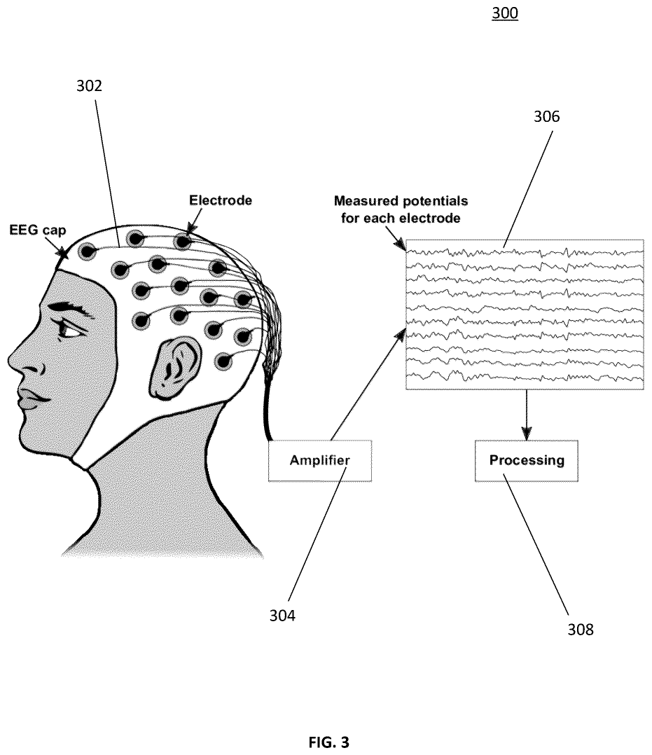

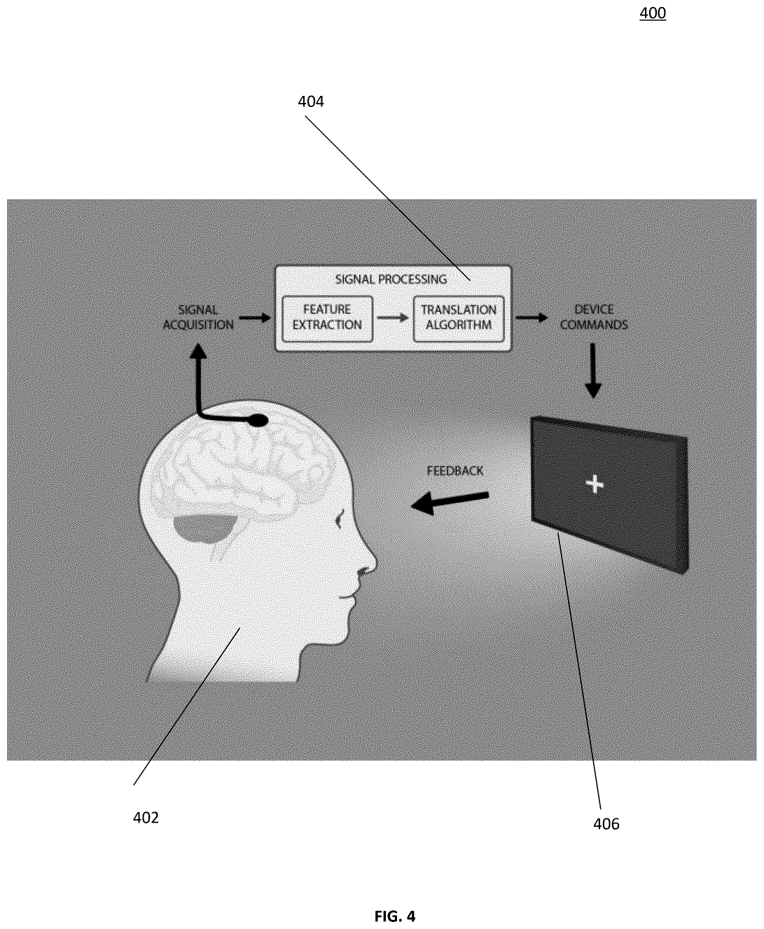

Turning now to FIG. 1, a diagram is shown of an example of a flight simulator 100 in accordance with disclosed embodiments. This example of a flight simulator 100 mimics a cockpit of an aircraft with a station/seat for the pilot 102, a full set of flight controls 104 and a tri-panel display that shows simulations of the view of the pilot during aircraft operations. Turning now to FIG. 2, a diagram of an example of an eye-tracker system 200 in accordance with disclosed embodiments. In this example, the pilot 202 observes the panel display 204 while a eye tracking sensor 206 follows the eye movement of the pilot 202 during the flight simulation. Turning now to FIG. 3, a diagram of an example of an electro-encephalogram (EEG) sensor 300 in accordance with disclosed embodiments. In this example, the pilot wears an EEG cap 302 with electrode sensors that monitor the pilot's neural signals. The neural signals are transmitted to an amplifier 304 which measures the data from each electrode 306 and sends the data on to the system for processing 308. Turning now to FIG. 4, a block diagram is shown of an example of a pilot assessment system based on cognitive neural data 400 in accordance with disclosed embodiments. In this example, as the pilot 402 sees and reacts to flight simulation tasks via the display 406, the pilot's vocalized words are acquired and processed 404 to translate into an individualized dataset for the pilot.

In one example, a pilot uses a flight simulator to perform an aircraft take-off. That pilot is equipped with sensor to measure brain activity which outputs to an AI model trained on similar data from pilots during other aircraft operations. As the simulated aircraft takes-off, the AI model would output the pilot's verbalized thought (“10 degree pitch, 3 degree rate rotation, gear up . . . jeez . . . sidewind is strong”), which is transcribed and then associated with simulator avionics panel data and behavior sensor (eye tracker) data. Based on the words that are transcribed, the qualitative data can be labeled into skills according to how the information is being used by the pilot. Using the previous transcript, the system would associate the internal monologue to the cognitive skill of “collection” of pitch and degree rotation information from the avionic instruments, the cognitive skill of “estimation” of how much the pilot needs to pull back on the yoke to nose-up into the 3-degree pitch, and the skill of “prediction” to assess the how much the sidewind will push them off flightpath.

Embodiments of the present disclosure uses ML to produce the transcribed inner monologue as well as label the monologue and simulator data by skills (e.g., manually or with an AI model). This labeled dataset works by using transcripts paired with various other data (e.g., observational behavioral data, simulator data, physiological data) to determine cognitive skills to develop an individualized assessment for the pilot. This assessment could be used to develop an individualized training plan for the pilot, to assess the effects of automated system designs on cognitive skills, or to screen individuals before they operate other types of vehicles (e.g., military vehicles, mining, emergency responders, spacecraft) or to determine if an individual is cognitively impaired.

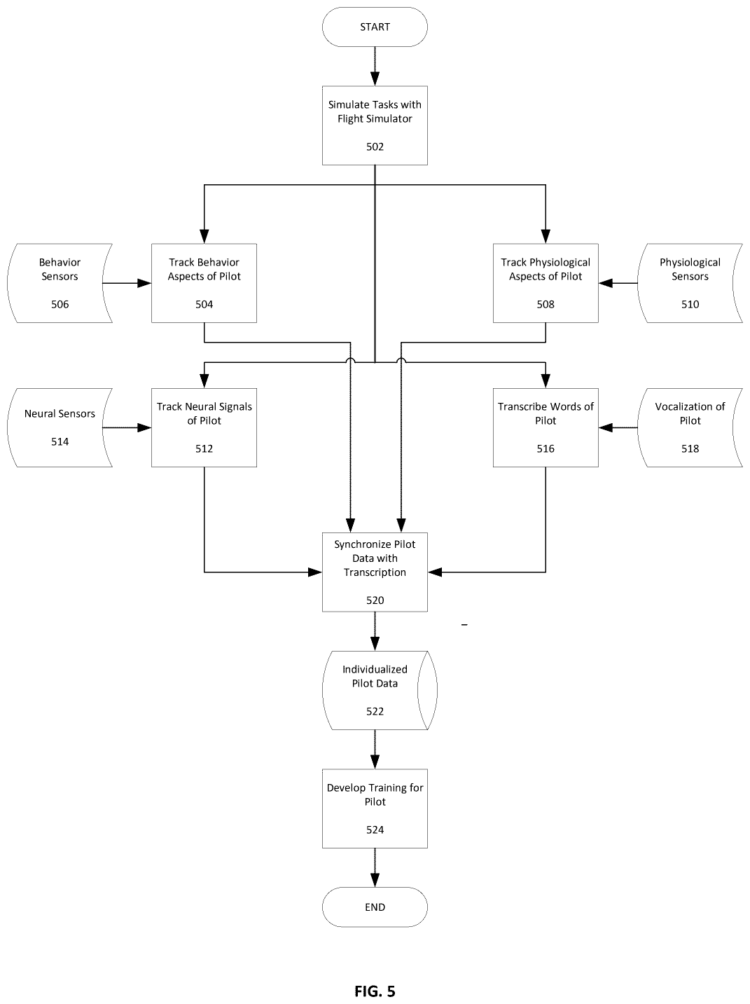

Turning now to FIG. 5, a flowchart 500 is shown of a method for developing an individualized assessment for a pilot based upon cognitive brain scan data in accordance with disclosed embodiments. First, simulating aircraft tasks for the pilot are simulated with an aircraft flight simulator 502. The behavioral aspects of the pilot 504 during the simulated aircraft tasks are tracked with behavior sensors 506. The physiological aspects of the pilot 508 during the simulated aircraft tasks are tracked with physiological sensors 510. The neural signals of the pilot 512 during the simulated aircraft tasks are tracked with neural brain sensors 514. The neural signals of the pilot into transcribed into words 516 based on vocalization from the pilot 518 during the simulated aircraft tasks with a transcription model. The behavioral aspects, the physiological aspects, the neural signals and the transcribed words of the pilot during the simulated aircraft tasks are all synchronized 520 into an individualized dataset for the pilot 522 with a data synchronization system, where the dataset is used to develop an individualized training assessment for the pilot 524.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

As used herein, the term “axial” refers to a direction that is generally parallel to or coincident with an axis of rotation, axis of symmetry, or centerline of a component or components. For example, in a cylinder or disc with a centerline and generally circular ends or opposing faces, the “axial” direction may refer to the direction that generally extends in parallel to the centerline between the opposite ends or faces. In certain instances, the term “axial” may be utilized with respect to components that are not cylindrical (or otherwise radially symmetric). For example, the “axial” direction for a rectangular housing containing a rotating shaft may be viewed as a direction that is generally parallel to or coincident with the rotational axis of the shaft. Furthermore, the term “radially” as used herein may refer to a direction or a relationship of components with respect to a line extending outward from a shared centerline, axis, or similar reference, for example in a plane of a cylinder or disc that is perpendicular to the centerline or axis. In certain instances, components may be viewed as “radially” aligned even though one or both of the components may not be cylindrical (or otherwise radially symmetric). Furthermore, the terms “axial” and “radial” (and any derivatives) may encompass directional relationships that are other than precisely aligned with (e.g., oblique to) the true axial and radial dimensions, provided the relationship is predominantly in the respective nominal axial or radial direction. As used herein, the term “substantially” denotes within 5% to account for manufacturing tolerances. Also, as used herein, the term “about” denotes within 5% to account for manufacturing tolerances.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A system for developing an individualized assessment for a pilot based upon cognitive brain scan data, comprising:
an aircraft simulator that simulates aircraft tasks for the pilot;
behavior sensors that track behavioral aspects of the pilot during the simulated aircraft tasks;
physiological sensors that track physiological aspects of the pilot during the simulated aircraft tasks;
neural brain sensors that track neural signals of the pilot during the simulated aircraft tasks;
a transcription model that transcribes the neural signals of the pilot into transcribed words based on vocalization from the pilot during the simulated aircraft tasks; and
a data synchronization system that synchronizes the behavioral aspects, the physiological aspects, the neural signals and the transcribed words of the pilot during the simulated aircraft tasks into an individualized dataset for the pilot, where the dataset is used to develop an individualized training assessment for the pilot.

2. The system of claim 1, where the aircraft simulator comprises a training vehicle.

3. The system of claim 1, where the aircraft simulator comprises a flight simulator.

4. The system of claim 1, where the aircraft simulator comprises a virtual reality (VR) simulator.

5. The system of claim 1, where the physiological sensors comprise an eye tracking device.

6. The system of claim 1, where the physiological sensors comprise a heart rate monitor.

7. The system of claim 1, where the neural brain sensors comprise a functional magnetic resonance imaging (FMRI) device.

8. The system of claim 1, where the neural brain sensors comprise an electro-encephalogram (EEG).

9. The system of claim 1, where the neural brain sensors comprise functional near-infrared spectroscope (FNIR).

10. A method for developing an individualized assessment for a pilot based upon cognitive brain scan data, comprising:
simulating aircraft tasks for the pilot with an aircraft simulator;
tracking behavioral aspects of the pilot during the simulated aircraft tasks with behavior sensors;
tracking physiological aspects of the pilot during the simulated aircraft tasks with physiological sensors;
tracking neural signals of the pilot during the simulated aircraft tasks with neural brain sensors;
transcribing the neural signals of the pilot into transcribed words based on vocalization from the pilot during the simulated aircraft tasks with a transcription model; and
synchronizing the behavioral aspects, the physiological aspects, the neural signals and the transcribed words of the pilot during the simulated aircraft tasks into an individualized dataset for the pilot with a data synchronization system; and
developing an individualized training assessment for the pilot using the dataset.

11. The method of claim 10, where the aircraft simulator comprises a training vehicle.

12. The method of claim 10, where the aircraft simulator comprises a flight simulator.

13. The method of claim 10, where the aircraft simulator comprises a virtual reality (VR) simulator.

14. The method of claim 10, where the physiological sensors comprise an eye tracking device.

15. The method of claim 10, where the physiological sensors comprise a heart rate monitor.

16. The method of claim 10, where the neural brain sensors comprise a functional magnetic resonance imaging (FMRI) device.

17. The method of claim 10, where the neural brain sensors comprise an electro-encephalogram (EEG).

18. The method of claim 10, where the neural brain sensors comprise functional near-infrared spectroscope (FNIR).
